(19) United States
(12) Patent Application Publication
(10) Pub. No.: US 2014/0237408 A1
(43) Pub. Date: Aug. 21, 2014

(54) INTERPRETATION OF PRESSURE BASED GESTURE

(71) Applicant: FlatFrog Laboratories AB, Lund (SE)

(72) Inventors: Nicklas OHLSSON, Bunkeflostrand (SE); Andreas OLSSON, Bjarred (SE)

(73) Assignee: FlatFrog Laboratories AB, Lund (SE)

(21) Appl. No.: 14/176,382

(22) Filed: Feb. 10, 2014

Related U.S. Application Data
(60) Provisional application No. 61/765,166, filed on Feb. 15, 2013.

(51) Int. Cl. G06F 3/0488; G06F 3/0484; G06F 3/0486

(52) U.S. Cl. CPC G06F 3/0488; G06F 3/0486; G06F 3/04842
USPC 715/769

(57) ABSTRACT

The invention relates to a method, a gesture interpretation unit and a touch sensing device, wherein the first and second positions are in a relation to a graphical interactive object corresponding to a grabbing input; and while continuous contact of the first and second objects with the touch surface is maintained: determining from the touch input data if movement of at least one of the first and second touch inputs has occurred, and if movement has occurred, moving the graphical interactive object in accordance with the determined movement; determining from the touch input data if an increased pressure compared to a threshold of at least one of the first and second touch inputs has occurred, and if an increased pressure has occurred, processing the graphical interactive object in response to the determined increased pressure.

This application claims priority under 35 U.S.C. §119 to U.S. application No. 61/765,166 filed on Feb. 15, 2013, the entire contents of which are hereby incorporated by reference.

### FIELD OF THE INVENTION

The present invention relates to interpretation of gestures on a touch sensing device, and in particular to interpretation of gestures comprising pressure or force.

### BACKGROUND OF THE INVENTION

Touch sensing systems (“touch systems”) are in widespread use in a variety of applications. Typically, the touch systems are actuated by a touch object such as a finger or stylus, either in direct contact, or through proximity (i.e. without contact), with a touch surface. Touch systems are for example used as touch pads of laptop computers, in control panels, and as overlays to displays on e.g. hand held devices, such as mobile telephones. A touch panel that is overlaid on or integrated in a display is also denoted a “touch screen”. Many other applications are known in the art.

To an increasing extent, touch systems are designed to be able to detect two or more touches simultaneously, this capability often being referred to as “multi-touch” in the art.

There are numerous known techniques for providing multi-touch sensitivity, e.g. by using cameras to capture light scattered off the point(s) of touch on a touch panel, or by incorporating resistive wire grids, capacitive sensors, strain gauges, etc into a touch panel.

WO2011/028169 and WO2011/049512 disclose multi-touch systems that are based on frustrated total internal reflection (FTIR). Light sheets are coupled into a panel to propagate inside the panel by total internal reflection (TIR). When an object comes into contact with a touch surface of the panel, the propagating light is attenuated at the point of touch. The transmitted light is measured at a plurality of outcoupling points by one or more light sensors. The signals from the light sensors are processed for input into an image reconstruction algorithm that generates a 2D representation of interaction across the touch surface. This enables repeated determination of current position/size/shape of touches in the 2D representation while one or more users interact with the touch surface. Examples of such touch systems are found in U.S. Pat. No. 3,673,327, U.S. Pat. No. 4,254,333, U.S. Pat. No. 6,972,753, US2004/0252091, US2006/0114237, US2007/0075648, WO2009/048365, US2009/0153519, WO2010/006882, WO2010/064983, and WO2010/134865.

In touch systems in general, there is a desire to not only determine the location of the touching objects, but also to estimate the amount of force by which the touching object is applied to the touch surface. This estimated quantity is often referred to as “pressure”, although it typically is a force. The availability of force/pressure information opens up possibilities of creating more advanced user interactions with the touch screen, e.g. by enabling new gestures for touch-based control of software applications or by enabling new types of games to be played on gaming devices with touch screens.

From EP-2088501-A1 it is known to manipulate components with touch-based finger gestures that are detected with touch sensing technology or any other suitable technology. A dragging gesture is disclosed, comprising three phases: 1) touching the touch-sensitive component with a pointing device (e.g. a finger), 2) moving the pointing device while maintaining the contact with the sensing device, and 3) lifting the pointing device from the sensing device. A zooming gesture is also explained, implemented as a screwing motion or increased pressure by a finger. An increased pressure is here detected as an increased area on the screen.

From US-20110050576-A1 a pressure sensitive user interface for mobile devices is known. The mobile device may be configured to measure an amount of pressure exerted upon the touch sensitive display surface during a zoom in/out two-finger pinch touch/movement and adjust the degree of magnification accordingly. Different touch sensitive surfaces such as pressure, capacitance, or induction sensing surfaces can be used.

Examples of touch force estimation in connection to a FTIR based touch-sensing apparatus is disclosed in the Swedish application SE-1251014-5. An increased pressure is here detected by an increased contact, on a microscopic scale, between a touching object and a touch surface with increasing application force. This increased contact may lead to a better optical coupling between the transmissive panel and the touching object, causing an enhanced attenuation (frustration) of the propagating radiation at the location of the touching object.

The great capabilities of multi touch-sensing technology to fast detect a large plurality of touches and pressures, give the technical base for new and advanced gestures providing new interaction capabilities for one or several users.

The object of the invention is to provide a new gesture including pressure which enables interaction with an object presented on a GUI of a touch sensing device.

### SUMMARY OF THE INVENTION

According to a first aspect, the object is at least partly achieved with a method according to the first independent claim. The method comprises: presenting a graphical interactive object via a graphical user interface, GUI, of a touch sensing device wherein the GUI is visible via a touch surface of the touch sensitive device; receiving touch input data indicating touch inputs on the touch surface, and determining from the touch input data:
a first touch input from a first object of a user at a first position on the touch surface, and
a second touch input from a second object of a user at a second position on the touch surface, wherein the first and second positions are in a relation to the graphical interactive object corresponding to a grabbing input; and while continuous contact of the first and second objects with the touch surface is maintained:
determining from the touch input data if movement of at least one of said first and second touch inputs has occurred, and if movement has occurred, moving the graphical interactive object in accordance with the determined movement;
determining from the touch input data if an increased pressure compared to a threshold of at least one of the first and second touch inputs has occurred, and if an increased pressure has occurred, processing the graphical interactive object in response to the determined increased pressure.

With the method a user is allowed to interact with a graphical interactive object in advanced ways. For example may new games be played where a user can control the graphical interactive object directly via touch inputs to the GUI. No separate game controller is then needed, and the appearance of a touch sensing device on which the method operates can be cleaner. The game will also be more intuitive to play, as most users will understand to grab the graphical interactive object, move the fingers over the GUI to make the object follow the movement of the fingers and press on the object to make it react in a certain way. Several users may interact with different graphical interactive objects at the same time on the same GUI to together play advances games. The user experience will be greatly enhanced and more realistic than if interacting with the object via a game controller such as a game pad or joystick.

According to one embodiment, the step of processing the graphical interactive object comprising processing the graphical interactive object according to a first action when an increased pressure of the first touch input is determined, and/or processing the graphical interactive object according to a second action when an increased pressure of the second touch input is determined. According to a further embodiment, the step of processing the graphical interactive object comprises processing the graphical interactive object according to a third action when essentially simultaneous increased pressures of the first and second touch inputs are determined. By having these features, the user can still make the graphical interactive object react in several ways, even if the hand of the user already is occupied with the graphical interactive object.

According to a further embodiment, the grabbing input is determined by determining from said touch input data that the first and second positions are arranged in space and/or in time according to a certain rule or rules. For example, the first and second positions are arranged such that they coincide at least in some extent with the graphical interactive object during overlapping time periods. According to another example, the method comprises determining a line corresponding to a distance between the first and second positions wherein a grabbing input corresponds to first and second positions which during overlapping time periods are arranged such that the line coincides with said graphical interactive object. The effect of these features is that it can be determined in a plurality of ways that a user wants to interact with the graphical interactive object. The graphical interactive object might be one of a several different graphical interactive objects visible for the user via a GUI on a touch surface. It might be a purpose to have a certain gesture, thus the grabbing input, which some of the graphical interactive objects are configured to react to, but not everyone.

According to a another embodiment, the step of determining of movement of at least one of said first and second touch inputs comprising determining from said touch input data that at least one of said first and second touch inputs are arranged in space and/or in time in a manner corresponding to movement of the at least one of said first and second touch inputs. Thus, it can be determined that any of both of the first and second touch inputs are moving.

According to one embodiment, the method comprises determining a line corresponding to a distance between the first and second touch inputs and moving the interactive graphical object as a function of the line when movement of at least one of said first and second touch inputs is determined. Thus, a relationship between the first and second touch inputs can be determined such that the interactive graphical object can be moved in a natural way according to the movement of the first and second touch inputs.

According to a further embodiment, the touch input data comprises positioning data xₙₜ, yₙₜ and pressure data pₙₜ. The positioning data may for example be a geometrical centre, a centre of mass, or a combination of both, of a touch input. The pressure data according to one embodiment is the total pressure, or force, of the touch input. According to another embodiment, the pressure data is a relative pressure, or force, of the touch input.

According to a second aspect, the object is at least partly achieved with a gesture interpretation unit comprising a processor configured to receive a touch signal s, comprising touch input data indicating touch inputs on a touch surface of a touch sensing device, the unit further comprises a computer readable storage medium storing instructions operable to cause the processor to perform operations comprising:
presenting a graphical interactive object via a graphical user interface, GUI, wherein the GUI is visible via the touch surface;
determining from said touch input data:
a first touch input from a first object of a user at a first position on the touch surface, and
a second touch input from a second object of a user at a second position on the touch surface, wherein said first and second positions are in a relation to the graphical interactive object corresponding to a grabbing input, and while continuous contact of said first and second objects with the touch surface is maintained:
determining from the touch input data if movement of at least one of said first and second touch inputs has occurred, and if movement has occurred, moving the graphical interactive object in accordance with the determined movement;
determining from the touch input data if an increased pressure compared to a threshold of at least one of the first and second touch inputs has occurred, and if an increased pressure has occurred, processing the graphical interactive object in response to the determined increased pressure.

According to a third aspect, the object is at least partly achieved with a touch sensing device comprising:
a touch arrangement comprising a touch surface, wherein the touch arrangement is configured to detect touch inputs on the touch surface and to generate a signal s_{y} indicating the touch inputs;
a touch control unit configured to receive the signal s_{y} and to determine touch input data from said touch inputs and to generate a touch signal s, indicating the touch input data;
a gesture interpretation unit according to any of the embodiments as described herein, wherein the gesture interpretation unit is configured to receive the touch signal sₓ.

According to one embodiment, the touch sensing device is an FTIR-based (Frustrated Total Internal Reflection) touch sensing device.

According to a fourth aspect, the object is at least partly achieved with a computer readable storage medium comprising computer programming instructions which, when executed on a processor, are configured to carry out the method as described herein.

Any of the above-identified embodiments of the method may be adapted and implemented as an embodiment of the second, third and/or fourth aspects.

Preferred embodiments are set forth in the dependent claims and in the detailed description.

### SHORT DESCRIPTION OF THE APPENDED DRAWINGS

Below the invention will be described in detail with reference to the appended figures, of which:

FIG. 1 illustrates a touch sensing device according to some embodiments of the invention.

FIGS. 2-3 are flowcharts of the method according to some embodiments of the invention.

FIG. 4A illustrates the GUI with a touch surface of a device when a graphical user interface object is presented on the GUI.

FIG. 4B illustrates the graphical user interface object presented on the display in FIG. 4A when a user is grabbing the object.

FIG. 4C illustrates the graphical user interface object when the user is pressing on the graphical user interface object.

FIG. 4D illustrates the graphical user interface object when it is moved across the GUI.

FIG. 5 illustrates a line between a first position of a first touch input and a second position of a second touch input, where the line coincide with the graphical interactive object.

FIG. 6A illustrates a side view of a touch sensing arrangement.

FIG. 6B is a top plan view of an embodiment of the touch sensing arrangement of FIG. 6A.

FIG. 7 is a flowchart of a data extraction process in the system of FIG. 6B.

FIG. 8 is a flowchart of a force estimation process that operates on data provided by the process in FIG. 7.

### DETAILED DESCRIPTION OF PREFERRED EMBODIMENTS OF THE INVENTION

### 1. Device

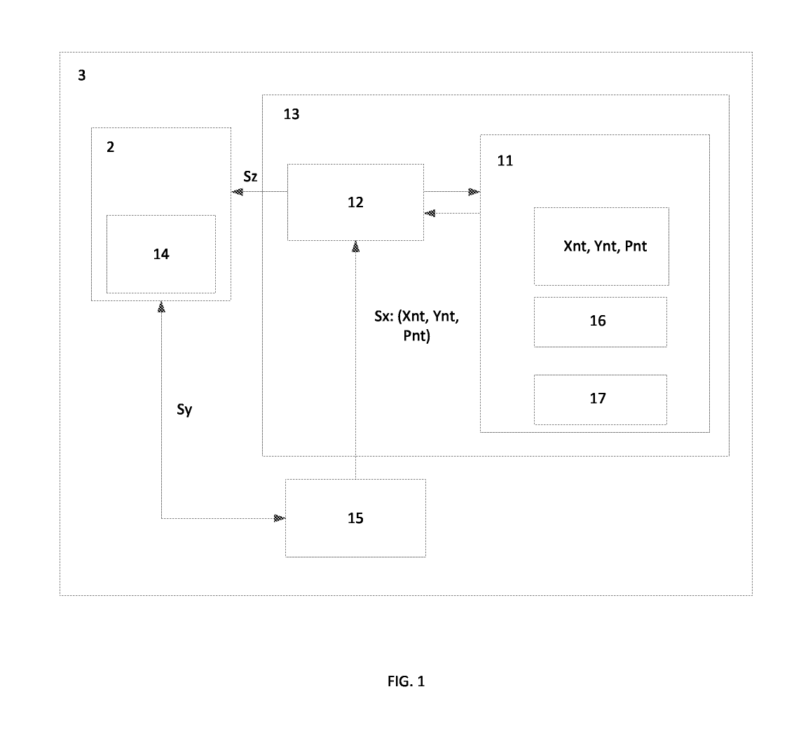

FIG. 1 illustrates a touch sensing device 3 according to some embodiments of the invention. The device 3 includes a touch arrangement 2, a touch control unit 15, and a gesture interpretation unit 13. These components may communicate via one or more communication buses or signal lines. According to one embodiment, the gesture interpretation unit 13 is incorporated in the touch control unit 15, and they may then be configured to operate with the same processor and memory. The touch arrangement 2 includes a touch surface 14 that is sensitive to simultaneous touches. A user can touch on the touch surface 14 to interact with a graphical user interface (GUI) of the touch sensing device 3. The device 3 can be any electronic device, portable or non-portable, such as a computer, gaming console, tablet computer, a personal digital assistant (PDA) or the like. It should be appreciated that the device 3 is only an example and the device 3 may have more components such as RF circuitry, audio circuitry, speaker, microphone etc. and be e.g. a mobile phone or a media player.

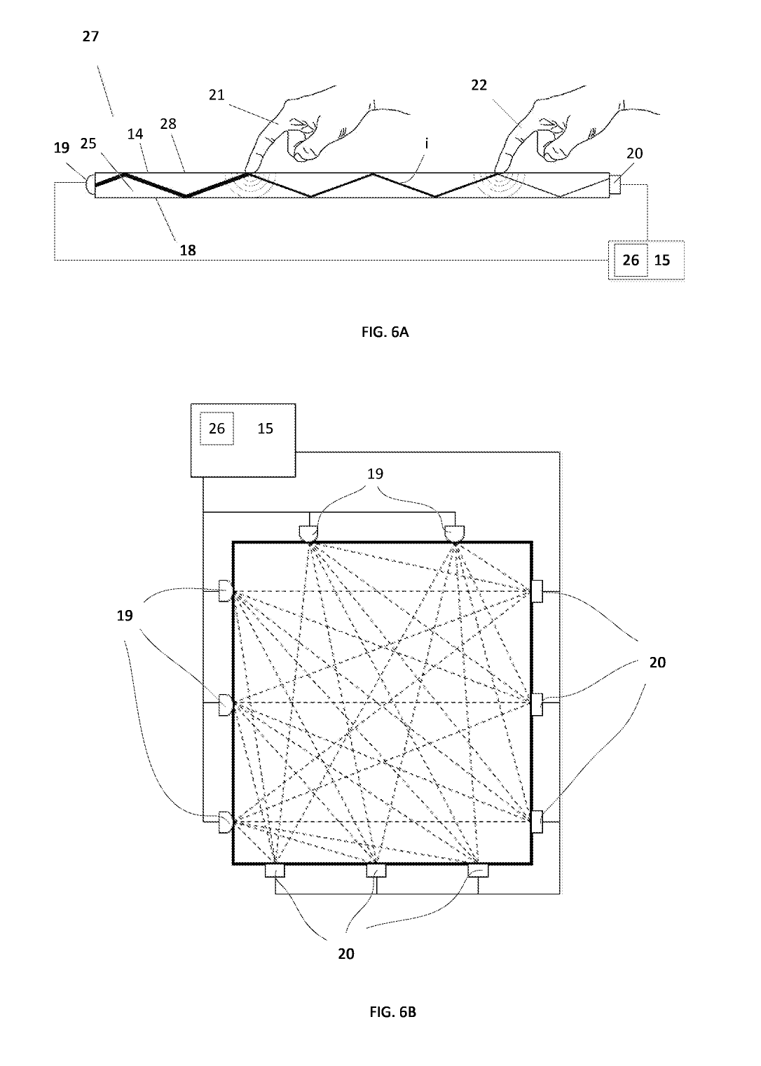

The touch surface 14 may be part of a touch sensitive display, a touch sensitive screen or a light transmissive panel 23 (FIG. 6A-6B). With the last alternative the light transmissive panel 23 is then overlaid on or integrated in a display and may be denoted a “touch sensitive screen”, or only “touch screen”. The touch sensitive display or screen may use LCD (Liquid Crystal Display) technology, LPD (Light Emitting Polymer) technology, OLED (Organic Light Emitting Diode) technology or any other display technology. The GUI displays visual output to the user via the display, and the visual output is visible via the touch surface 14. The visual output may include text, graphics, video and any combination thereof.

The touch surface 14 receives touch inputs from one or several users. The touch arrangement 2, the touch surface 14 and the touch control unit 15 together with any necessary hardware and software, depending on the touch technology used, detect the touch inputs. The touch arrangement 2, the touch surface 14 and touch control unit 15 may also detect touch input including movement of the touch inputs using any of a plurality of known touch sensing technologies capable of detecting simultaneous contacts with the touch surface 14. Such technologies include capacitive, resistive, infrared, and surface acoustic wave technologies. An example of a touch technology which uses light propagating inside a panel will be explained in connection with FIG. 6A-6B.

The touch arrangement 2 is configured to generate and send the touch inputs as one or several signals s_{y} to the touch control unit 15. The touch control unit 15 is configured to receive the one or several signals s_{y} and comprises software and hardware to analyse the received signals s_{y}, and to determine touch input data including sets of positions xₙₜ, yₙₜ with associated pressure Pₜ on the touch surface 14 by processing the signals s_{y}. Each set of touch input data xₙₜ, yₙₜ, pₙₜ may also include identification, an ID, identifying to which touch input the data pertain. Here “n” denotes the identity of the touch input. If the touch input is still or moved over the touch surface 14, without losing contact with it, a plurality of touch input data xₙₜ, yₙₜ, Pₙₜ with the same ID will be determined. If the touch input is taken away from the touch surface 14, there will be no more touch input data with this ID. Touch input data from a touch inputs 4, 7 may also comprise an area aₙₜ of the touch. A position xₙₜ, yₙₜ referred to herein is then a centre of the area aₙₜ. A position may also be referred to as a location. The touch control unit 15 is further configured to generate one or several touch signals s, comprising the touch input data, and to send the touch signals s, to a processor 12 in the gesture interpretation unit 13. The processor 12 may e.g. be a computer programmable unit (CPU). The gesture interpretation unit 13 comprises a computer readable storage medium 11, which may include a volatile memory such as high speed random access memory (RAM-memory) and/or a non-volatile memory such as a flash memory.

The computer readable storage medium 11 comprises a touch module 16 (or set of instructions), and a graphics module 17 (or set of instructions). The computer readable storage medium 11 comprises computer programming instructions which, when executed on the processor 12, are configured to carry out the method according to any of the steps described herein. These instructions can be seen as divided between the modules 16, 17. The computer readable storage medium 11 may also store received touch input data comprising positions xₙₜ, yₙₜ on the touch surface 14, pressures Pₜ of the touch inputs, and their IDs, respectively. The touch module 16 includes instructions to determine from the touch input data if the touch inputs have certain characteristics, such as being in a predetermined relation to a graphical interactive object 1, and/or if one or several of the touch inputs are moving, and/or if continuous contact with the touch surface 14 is maintained or is stopped, and/or the pressure of the one or several touch inputs. The touch module 16 thus keeps track of the touch inputs. Determining movement of a touch input may include determining a speed (magnitude), velocity (magnitude and direction) and/or acceleration (magnitude and/or direction) of the touch input or inputs.

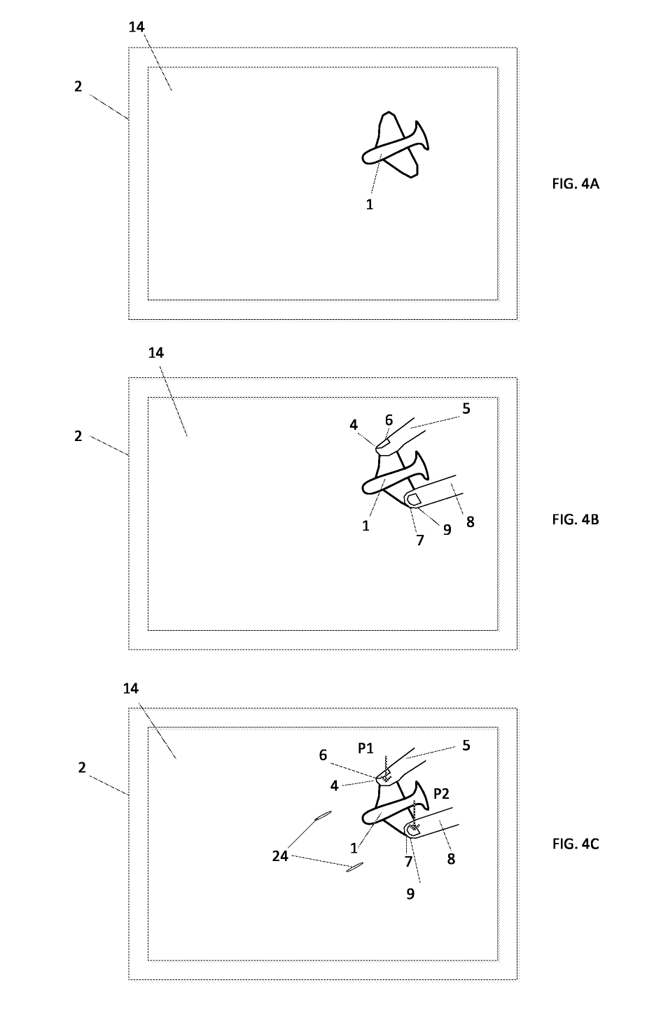

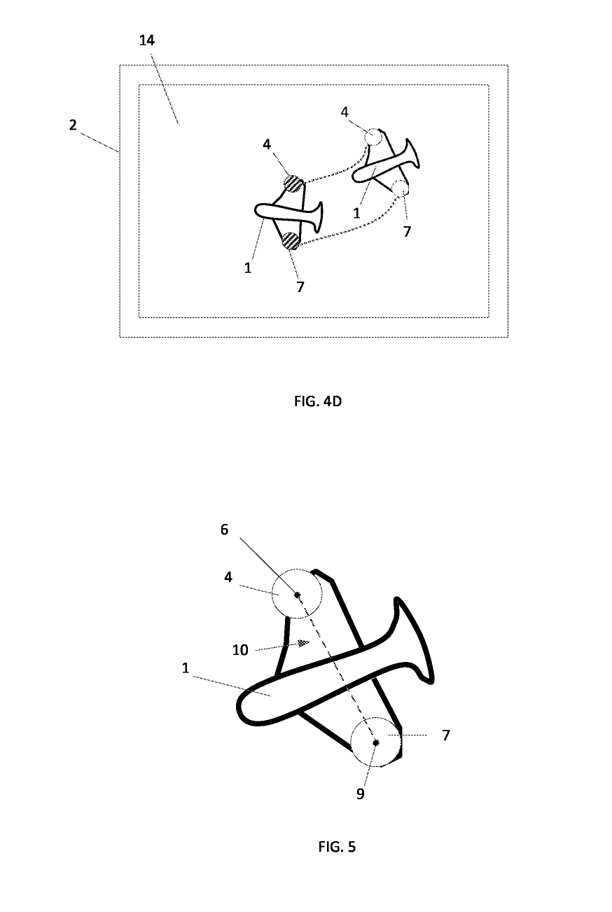

The graphics module 17 includes instructions for rendering and displaying graphics via the GUI. The graphics module 17 controls the position, movements, and actions etc. of the graphics. More specifically, the graphics module 17 includes instructions for displaying at least one graphical interactive object 1 (FIG. 4A-5) on or via the GUI and moving it and make it react in response to certain determined touch inputs. The term “graphical” include any visual object that can be presented on the GUI and be visible for the user, such as text, icons, digital images, animations or the like. The term “interactive” includes any object that a user can affect via touch inputs to the GUI. For example, if the user makes touch inputs on the touch surface 14 when a graphical interactive object 1 is displayed, the graphical interactive object 1 will react to the touch inputs if the touch inputs have certain characteristics that will be explained in the following. The processor 12 is configured to generate signals s_{z} or messages with instructions to the GUI how the graphical interactive object 1 shall be processed and controlled, e.g. moved, change its appearance etc. The processor 12 is further configured to send the signals s_{z} or messages to the touch arrangement 2, where the GUI via a display is configured to receive the signals s_{z} or messages and control the graphical interactive object 1 according to the instructions.

The gesture interpretation unit 13 may thus be incorporated in any known touch sensing device 3 with a touch surface 14, wherein the device 3 is capable of presenting the graphical interactive object 1 via a GUI visible on the touch surface 14, detect touch inputs on the touch surface 14 and to generate and deliver touch input data to the processor 12. The gesture interpretation unit 13 is then incorporated into the device 3 such that it can process the graphical interactive object 1 in predetermined ways when certain touch data has been determined.

### 2. Gesture

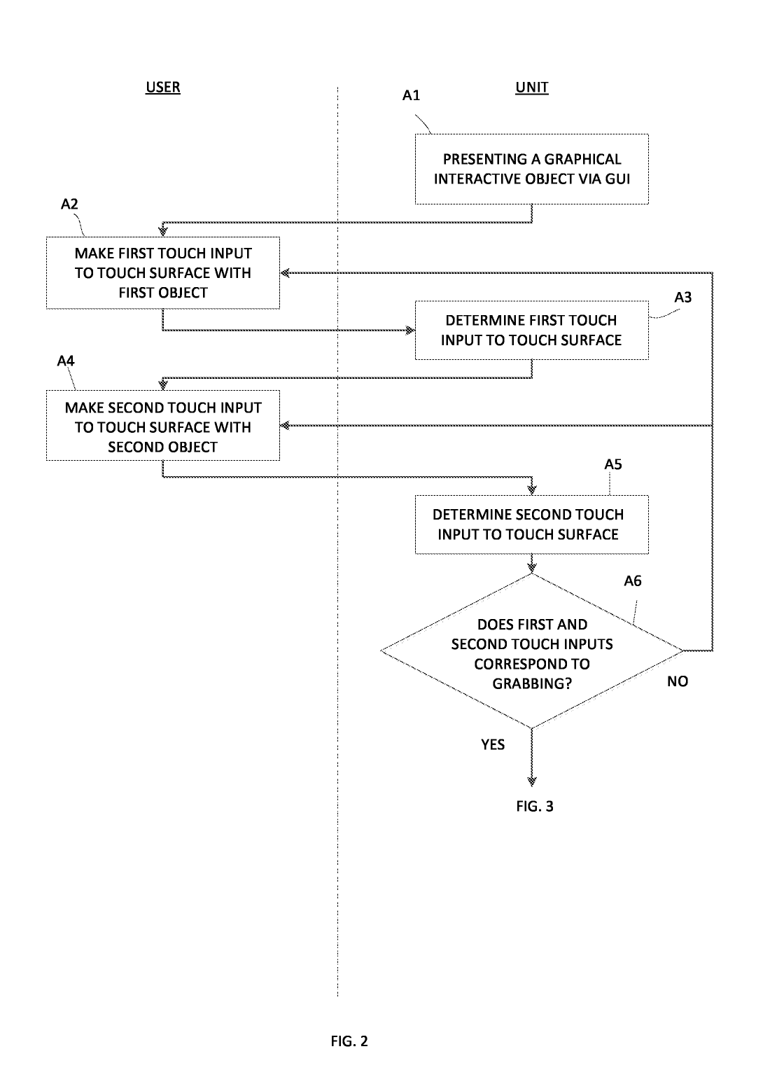

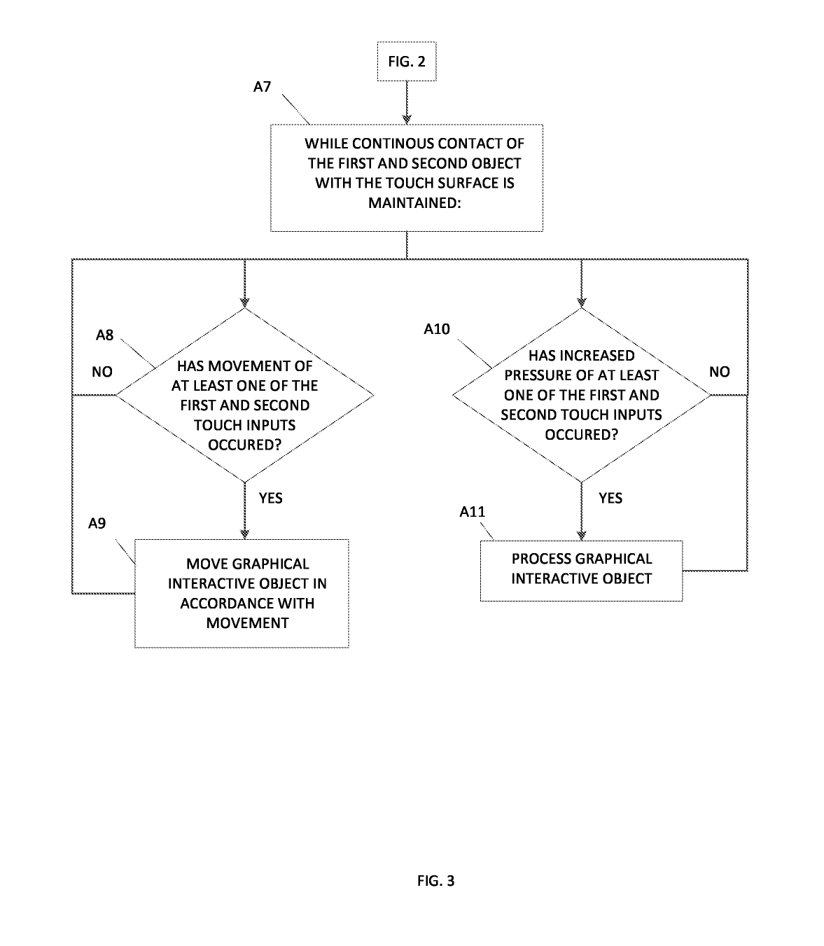

FIGS. 2 and 3 is a flowchart illustrating a method according to some embodiments of the invention, when a user interacts with a graphical interactive object 1 according to a certain pattern. The left side of the flowchart in FIG. 2 illustrates the touch inputs made by a user, and the right side of the flowchart illustrates how the gesture interpretation unit 13 responds to the touch inputs. The left and the right sides of the flowchart are separated by a dotted line. The method may be preceded by setting the touch sensing device 3 in a certain state, e.g. an interaction state such as a gaming state. This certain state may invoke the function of the gesture interpretation unit 13, and the method which will now be described with reference to FIGS. 2 and 3.

At first, the graphical interactive object 1 is presented via the GUI of the touch sensing device 3 (A1). The graphical interactive object 1 may be a graphical interactive object 1 in a game, e.g. an aeroplane, a car, an animated person etc. The user may now initiate interaction with the graphical interactive object 1 by making certain touch inputs on the touch surface 14. If the touch inputs correspond to a grabbing input, the user may further interact with the graphical interactive object 1 as long as continuous contact with the touch surface 14 is maintained. For making a grabbing input, the user makes a first touch input 4 on the touch surface 14 with a first object 5 (A2). The first touch input 4 to the touch surface 14 can then be determined, including the position x₁ₜ, y₁ₜ of the first object 5 on the touch surface 14(A3). The user now makes a second touch input 7 to the touch surface 14 with a second object 8 (A4). The second touch input to the touch surface 14 can then be determined, including the position x₂ₜ, y₂ₜ of the second object 8 on the touch surface 14 (A5). Thereafter it is determined if the first and second touch inputs 4, 7 corresponds to a grabbing input (A6). A grabbing input grabbing the graphical interactive object 1 corresponds to touch input data arranged in space and/or in time according to a certain rule or rules. To qualify for a grabbing input according to a first embodiment, the first object 5 and the second object 8 have to be present on the touch surface 14 during overlapping time periods. Overlapping time periods can be determined by comparing timing of the determined position x₁ₜ, y₁ₜ of the first object 5 and the position x₂ₜ, y₂ₜ of the second object 8. To qualify for a grabbing input according to a second embodiment, the positions x₁ₜ, y₁ₜ of the first object 5 and the position x₂ₜ, y₂ₜ of the second object 8 are arranged such that they coincide at least in some extent with the graphical interactive object 1 during overlapping time periods, thus, coincides with the location or position of the graphical interactive object 1. According to a third embodiment, the method comprises determining a line corresponding to a distance between the positions x₁ₜ, y₁ₜ of the first object 5 and the position x₂ₜ, y₂ₜ of the second object 8. This line is further illustrated in FIG. 5. A grabbing input then corresponds to positions x₁ₜ, y₁ₜ of the first object 5 and the position x₂ₜ, y₂ₜ of the second object 8 which during overlapping time periods are arranged such that the line coincides with the graphical interactive object 1. If a grabbing input then can be determined, the graphical interactive object 1 is configured to react to further inputs made from the first and second objects 5, 8 as long as continuous contact with the touch surface 14 of the first and second objects 5, 8 is maintained. Overlapping time periods can be determined as the touch input data is time stamped. For example, the user may first put down the first finger 5 on the graphical interactive object 1 and then put down the second finger 8 on the graphical interactive object 1 while the first finger 5 is maintained on the graphical interactive object 1. The touch inputs will then be present on the touch surface 14 during overlapping time periods.

If the first and second touch inputs 4, 7 do not correspond to a grabbing input, the method returns to determining a first and/or a second 4, 7 touch input. Depending on if one or both of the first and second objects 5, 8 has stopped touching the touch surface 14, or if none of the touch inputs 4, 7 are close to qualify for a grabbing input, the method returns to step A3 or A5.

The first and second touch inputs 4, 7 are illustrated in the flowchart as occurring in a specific order, but these touch inputs 4, 7 may appear in opposite order and/or simultaneously. The first and second touch inputs 4, 7 may thus also be determined in an opposite order and/or simultaneously.

If a grabbing input has been determined and while continuous contact of the first and second objects 4, 7 with the touch surface 14 is maintained (A7), the method continues as illustrated in the flowchart in FIG. 3. It is now determining from touch input data if movement of at least one of the first and second touch inputs 4, 7 has occurred (A8). If movement has occurred, the graphical interactive object is moved in accordance with the determined movement of the first and second touch inputs 4, 7 (A9) while continuous contact of the first and second objects 5, 8 with the touch surface 14 is maintained. As long as the first and second objects 5, 8 are in continuous contact with the touch surface 14, it is determined if any or both of the first and second touch inputs 4, 7 are moving and the graphical interactive object 1 will be moved accordingly. According to one embodiment, a movement of at least one of the first and second touch inputs 4, 7 comprises determining from the touch input data that at least one of the first and second touch inputs 4, 7 are arranged in space and/or in time in a manner corresponding to movement of the at least one of the first and second touch inputs 4, 7. Determining movement of a touch input may include determining a speed (magnitude), velocity (magnitude and direction) and/or acceleration (magnitude and/or direction) of the touch input. According to one embodiment, the method comprises determining a line 10 (FIG. 10) corresponding to a distance between the first and second touch inputs 4, 7 and moving the interactive graphical object 1 as a function of the line 10 when movement of at least one of the first and second touch inputs 4, 7 has been determined.

Further, the method determines from the touch input data if an increased pressure compared to a threshold of at least one of the first and second touch inputs 4, 7 has occurred (A10) while continuous contact of the first and second objects 5, 8 with the touch surface 14 is maintained. If an increased pressure has occurred, the graphical interactive object 1 is processed in response to the determined increased pressure (A11).

Thus, if the user increases the pressure of at least one of the first and second touch inputs 5, 8, the graphical interactive object 1 will react in response to the increased pressure or pressures. The increased pressure is determined by comparing pressure data pₙₜ for a touch input with a threshold. The threshold may be different for the different touch inputs 5, 8. A pressure is in most cases related to a touch input, thus, the increased pressure will be a relative increase in pressure compared to a previous pressure value, or may be an increase in pressure compared to a function of a plurality of previous pressure values. Other statistical methods using previous pressure values may be used to determine if a pressure increase has occurred. Generally, a pressure increase may be determined using one of a plurality of known methods for determining an increase of a value based on a previous time series of the value. The pressure increase is according to a further embodiment an absolute increase and is determined compared to a pre-set pressure value. Thus, the threshold may be a previous pressure value, a function of a plurality of previous pressure values, a pre-set pressure value; or the threshold may be in any other ways statistically determined. As will later be explained, the herein mentioned pressure values may instead be force values. An increased pressure is thus determined and in response the graphical interactive object 1 is processed. The user may increase the pressure of at least one of the first and second touch objects 5, 8 several times and the graphical interactive object 1 will then be processed accordingly. For example, the graphical interactive object 1 may react several times, or may react in a certain manner after a certain number of subsequent pressure increases within a pre-set time.

According to one embodiment, the graphical interactive object 1 is processed according to a first action when an increased pressure of the first touch input 4 is determined. According to a further embodiment, the graphical interactive object 1 is processed according to a second action when an increased pressure of the second touch input 7 is determined. According to a still further embodiment, the graphical interactive object 1 is processed according to a third action when essentially simultaneous increased pressures of the first and second touch inputs 4, 7 are determined. An action may include making a state change of the graphical interactive object 1 such as making the graphical interactive object 1 start firing, placing a bomb or change colour, or making a certain movement of the graphical interactive object 1, such as moving to a certain “home”-place on the touch surface 14 or GUI.

The method continues to determine if movement of any or both of the first and second touch inputs 4, 7 has occurred (A8), and if a pressure increase of any or both of the first and second touch inputs has occurred (A10), and so on. Thus, the two branches of the flowchart in FIG. 3 are according to this embodiment processed simultaneously in time. The graphical interactive object 1 may thus simultaneously move and be processed according to an action, e.g. simultaneously move and fire.

According to one embodiment, for processing the graphical interactive object 1, it is a prerequisite that movement of the first and second touch inputs has halted. Thus, a user may move the graphical interactive object 1, halt the movement, and press to for example fire. The action may then be another action than the previous actions.

In the text and figures it is referred to only one graphical interactive object 1, but it is understood that a plurality of independent graphical interactive objects 1 may be displayed via the GUI at the same time and that one or several users may interact with the different graphical interactive objects 1 independently of each other as explained herein.

The graphical interactive object 1 may also include indicators such as flashing circles to indicate for the user where to place his fingers to qualify for a grabbing input. The processor 12 may then be configured to match the positions of the circles and the positions of the touch input data to determine if a grabbing input has occurred.

FIGS. 4A-4D illustrates the touch surface 14 of various points of performance of the method according to some embodiments of the invention. In FIG. 4A the graphical interactive object 1, here in the shape of a small airplane 1, is presented via the GUI and is visible from the touch surface 14. As shown in the figures, the touch surface 14 is here surrounded by a frame. In FIG. 4B a first and a second object 5, 8 are illustrated in the shape of two fingers 5, 8 from a user. The user has placed the first finger 5 at a first position 6 x₁ₜ, y₁ₜ on the airplane 1, and the second finger 8 at a second position 9 x₂ₜ, y₂ₜ on the airplane 1. A first touch input 4 and a second touch input 7 are then detected by the touch control unit 15. These touch inputs are receive to the processor 12 in the gesture interpretation unit 13 as touch input data with position coordinates x₁ₜ, y₁ₜ and x₂ₜ, y₂ₜ. The positions are analysed to determine if the positions are arranged such that they corresponds to a grapping input. If this is the case, the graphical interactive object 1 will now move according to the movement of the first and second fingers 5, 8 as long as the fingers 5, 8 are in continuous contact with the touch surface 14. The airplane 1 will now also respond in certain ways if the pressure of one or both of the first and second touch inputs 4, 7 is increased, as long as continuous contact with the touch surface 14 is maintained. As illustrated in FIG. 4C the first and second fingers 5, 8 are pressing on the airplane 1 with pressure P1 and P2. The pressures are detected by the touch control unit 15 and received to the processor 12 in the gesture interpretation unit 13 as touch input data with pressures p₁ₜ and p₂ₜ, and their positions, respectively. The pressures are analysed to determine if they have increased compared to a threshold, respectively, and qualify for processing the airplane 1. Here the two pressures P1 and P2 qualify, and in response the airplane 1 is firing ammunition 24 from two sides of the airplane 1. In FIG. 4D it is illustrated that after a grabbing input has been determined and as long as the first and second fingers 5, 8 are in continuous contact with the touch surface 14, the airplane 1 will move in accordance with the movement of the first and second fingers 5, 8. The first and second fingers 5, 8 are here not shown for simplicity, instead two circles are shown indicating the touch inputs 4, 7 from the first and second fingers 5, 8. As can be seen from the figure, the airplane 1 is moved in accordance with the movement of the first and second fingers 5, 8, thus in accordance with the movement of the touch inputs 4, 7.

In FIG. 5 it is illustrated how a grabbing input can be determined. The grabbing input of the first and second objects 5, 8 is determined from the touch input data. As has been previously explained, the touch input data comprises positioning data xₙₜ, yₙₜ and pressure data pₙₜ for each detected touch. The touch inputs thus indicate the first position 6 x₁ₜ, y₁ₜ and the second position 9 x₂ₜ, y₂ₜ of the first and second touch inputs. These positions are analysed to determine if they corresponds to a grabbing input. According to one embodiment, the method comprises determining a line 10 corresponding to a distance between the first and second positions 6, 9 wherein a grabbing input corresponds to first and second positions 6, 9 which during overlapping time periods are arranged such that the line 10 coincides with the graphical interactive object 1. An example is illustrated in FIG. 5, where a line 10 between the first position 6 of the first touch input 4 and the second position 9 of the second touch input 7 is shown, wherein the line 10 coincides with the graphical interactive object 1. It is also determined that the first and second touch inputs 4, 7 are present on the touch surface 14 during overlapping time periods.

### 3. Touch Technology Based on FTIR

As explained before, the invention can be used together with several kinds of touch technologies. One kind of touch technology based on FTIR will now be explained. The touch technology can advantageously be used together with the invention to deliver touch input data Xₙₜ, yₙₜ, pₙₜ, to the processor 12 of the gesture interpretation unit 13.

In FIG. 6A a side view of an exemplifying arrangement 27 for sensing touches in a known touch sensing device is shown. The arrangement 27 may e.g. be part of the touch arrangement 2 illustrated in FIG. 1A. The arrangement 27 includes a light transmissive panel 25, a light transmitting arrangement comprising one or more light emitters 19 (one shown) and a light detection arrangement comprising one or more light detectors 20 (one shown). The panel 25 defines two opposite and generally parallel top and bottom surfaces 14, 18 and may be planar or curved. In FIG. 6A, the panel 25 is rectangular, but it could have any extent. A radiation propagation channel is provided between the two boundary surfaces 14, 18 of the panel 25, wherein at least one of the boundary surfaces 14, 18 allows the propagating light to interact with one or several touching object 21, 22. Typically, the light from the emitter(s) 19 propagates by total internal reflection (TIR) in the radiation propagation channel, and the detector(s) 20 are arranged at the periphery of the panel 25 to generate a respective output signal which is indicative of the energy of received light.

As shown in the FIG. 6A, the light may be coupled into and out of the panel 25 directly via the edge portions of the panel 25 which connects the top 28 and bottom surfaces 18 of the panel 25. The previously described touch surface 14 is according to one embodiment at least part of the top surface 28. The detector(s) 20 may instead be located below the bottom surface 18 optically facing the bottom surface 18 at the periphery of the panel 25. To direct light from the panel 25 to the detector(s) 20, coupling elements might be needed. The detector(s) 20 will then be arranged with the coupling element(s) such that there is an optical path from the panel 25 to the detector(s) 20. In this way, the detector(s) 20 may have any direction to the panel 25, as long as there is an optical path from the periphery of the panel 25 to the detector(s) 20. When one or several objects 21, 22 is/are touching a boundary surface of the panel 25, e.g. the touch surface 14, part of the light may be scattered by the object(s) 21, 22, part of the light may be absorbed by the object(s) 21, 22 and part of the light may continue to propagate unaffected. Thus, when the object(s) 21, 22 touches the touch surface 14, the total internal reflection is frustrated and the energy of the transmitted light is decreased. This type of touch-sensing apparatus is denoted “FTIR system” (FTIR—Frustrated Total Internal Reflection) in the following. A display may be placed under the panel 25, i.e. below the bottom surface 18 of the panel. The panel 25 may instead be incorporated into the display, and thus be a part of the display.

The location of the touching objects 21, 22 may be determined by measuring the energy of light transmitted through the panel 15 on a plurality of detection lines. This may be done by e.g. operating a number of spaced apart light emitters 19 to generate a corresponding number of light sheets into the panel 25, and by operating the light detectors 20 to detect the energy of the transmitted energy of each light sheet. The operating of the light emitters 19 and light detectors 20 may be controlled by a touch processor 26. The touch processor 26 is configured to process the signals from the light detectors 20 to extract data related to the touching object or objects 21, 22. The touch processor 26 is part of the touch control unit 15 as indicated in the figures. A memory unit (not shown) is connected to the touch processor 26 for storing processing instructions which, when executed by the touch processor 26, performs any of the operations of the described method.

The light detection arrangement may according to one embodiment comprise one or several beam scanners, where the beam scanner is arranged and controlled to direct a propagating beam towards the light detector(s).

As indicated in FIG. 6A, the light will not be blocked by a touching object 21, 22. If two objects 21 and 22 happen to be placed after each other along a light path from an emitter 19 to a detector 20, part of the light will interact with both these objects 21, 22. Provided that the light energy is sufficient, a remainder of the light will interact with both objects 21, 22 and generate an output signal that allows both interactions (touch inputs) to be identified. Normally, each such touch input has a transmission in the range 0-1, but more usually in the range 0.7-0.99. The total transmission t, along a light path i is the product of the individual transmissions tₖ of the touch points on the light path: tᵢ=Πₖ₌₁ⁿtₖ. Thus, it may be possible for the touch processor 26 to determine the locations of multiple touching objects 21, 22, even if they are located in the same line with a light path.

FIG. 6B illustrates an embodiment of the FTIR system, in which a light sheet is generated by a respective light emitter 19 at the periphery of the panel 25. Each light emitter 19 generates a beam of light that expands in the plane of the panel 25 while propagating away from the light emitter 19. Arrays of light detectors 20 are located around the perimeter of the panel 25 to receive light from the light emitters 19 at a number of spaced apart outcoupling points within an outcoupling site on the panel 25. As indicated by dashed lines in FIG. 6B, each sensor-emitter pair 19, 20 defines a detection line. The light detectors 20 may instead be placed at the periphery of the bottom surface 18 of the touch panel 25 and protected from direct ambient light propagating towards the light detectors 20 at an angle normal to the touch surface 14. One or several detectors 20 may not be protected from direct ambient light, to provide dedicated ambient light detectors.

The detectors 20 collectively provide an output signal, which is received and sampled by the touch processor 26. The output signal contains a number of sub-signals, also denoted “projection signals”, each representing the energy of light emitted by a certain light emitter 19 and received by a certain light sensor 20. Depending on implementation, the processor 12 may need to process the output signal for separation of the individual projection signals. As will be explained below, the processor 12 may be configured to process the projection signals so as to determine a distribution of attenuation values (for simplicity, referred to as an “attenuation pattern”) across the touch surface 14, where each attenuation value represents a local attenuation of light.

### 4. Data Extraction Process in an FTIR System

FIG. 7 is a flow chart of a data extraction process in an FTIR system. The process involves a sequence of steps B1-B4 that are repeatedly executed, e.g. by the touch processor 26 (FIG. 6A). In the context of this description, each sequence of steps B1-B4 is denoted a frame or iteration. The process is described in more detail in the Swedish application No 1251014-5, filed on Sep. 11, 2012, which is incorporated herein in its entirety by reference.

Each frame starts by a data collection step B1, in which measurement values are obtained from the light detectors 20 in the FTIR system, typically by sampling a value from each of the aforementioned projection signals. The data collection step B1 results in one projection value for each detection line. It may be noted that the data may, but need not, be collected for all available detection lines in the FTIR system. The data collection step B1 may also include pre-processing of the measurement values, e.g. filtering for noise reduction.

In a reconstruction step B2, the projection values are processed for generation of an attenuation pattern. Step B2 may involve converting the projection values into input values in a predefined format, operating a dedicated reconstruction function on the input values for generating an attenuation pattern, and possibly processing the attenuation pattern to suppress the influence of contamination on the touch surface (fingerprints, etc.).

In a peak detection step B3, the attenuation pattern is then processed for detection of peaks, e.g. using any known technique. In one embodiment, a global or local threshold is first applied to the attenuation pattern, to suppress noise. Any areas with attenuation values that fall above the threshold may be further processed to find local maxima. The identified maxima may be further processed for determination of a touch shape and a center position, e.g. by fitting a two-dimensional second-order polynomial or a Gaussian bell shape to the attenuation values, or by finding the ellipse of inertia of the attenuation values. There are also numerous other techniques as is well known in the art, such as clustering algorithms, edge detection algorithms, standard blob detection, water shedding techniques, flood fill techniques, etc. Step B3 results in a collection of peak data, which may include values of position, attenuation, size, and shape for each detected peak. The attenuation may be given by a maximum attenuation value or a weighted sum of attenuation values within the peak shape.

In a matching step B4, the detected peaks are matched to existing traces, i.e. traces that were deemed to exist in the immediately preceding frame. A trace represents the trajectory for an individual touching object on the touch surface as a function of time. As used herein, a “trace” is information about the temporal history of an interaction. An “interaction” occurs when the touch object affects a parameter measured by a sensor. Touches from an interaction detected in a sequence of frames, i.e. at different points in time, are collected into a trace. Each trace may be associated with plural trace parameters, such as a global age, an attenuation, a location, a size, a location history, a speed, etc. The “global age” of a trace indicates how long the trace has existed, and may be given as a number of frames, the frame number of the earliest touch in the trace, a time period, etc. The attenuation, the location, and the size of the trace are given by the attenuation, location and size, respectively, of the most recent touch in the trace. The “location history” denotes at least part of the spatial extension of the trace across the touch surface, e.g. given as the locations of the latest few touches in the trace, or the locations of all touches in the trace, a curve approximating the shape of the trace, or a Kalman filter. The “speed” may be given as a velocity value or as a distance (which is implicitly related to a given time period). Any known technique for estimating the tangential speed of the trace may be used, taking any selection of recent locations into account. In yet another alternative, the “speed” may be given by the reciprocal of the time spent by the trace within a given region which is defined in relation to the trace in the attenuation pattern. The region may have a pre-defined extent or be measured in the attenuation pattern, e.g. given by the extent of the peak in the attenuation pattern.

The matching step B4 may be based on well-known principles and will not be described in detail. For example, step B4 may operate to predict the most likely values of certain trace parameters (location, and possibly size and shape) for all existing traces and then match the predicted values of the trace parameters against corresponding parameter values in the peak data produced in the peak detection step B3. The prediction may be omitted. Step B4 results in “trace data”, which is an updated record of existing traces, in which the trace parameter values of existing traces are updated based on the peak data. It is realized that the updating also includes deleting traces deemed not to exist (caused by an object being lifted from the touch surface 14, “touch up”), and adding new traces (caused by an object being put down on the touch surface 14, “touch down”).

Following step B4, the process returns to step B1. It is to be understood that one or more of steps B1-B4 may be effected concurrently. For example, the data collection step B1 of a subsequent frame may be initiated concurrently with any one of the steps B2-B4.

The result of the method steps B1-B4 is trace data, which includes data such as positions (xₙₜ, yₙₜ) for each trace. This data has previously been referred to as touch input data.

### 5. Detect Pressure

The current attenuation of the respective trace can be used for estimating the current application force for the trace, i.e. the force by which the user presses the corresponding touching object against the touch surface. The estimated quantity is often referred to as a “pressure”, although it typically is a force. The process is described in more detail in the above-mentioned application No. 1251014-5. It should be recalled that the current attenuation of a trace is given by the attenuation value that is determined by step B2 (FIG. 7) for a peak in the current attenuation pattern.

According to one embodiment, a time series of estimated force values is generated that represent relative changes in application force over time for the respective trace. Thereby, the estimated force values may be processed to detect that a user intentionally increases or decreases the application force during a trace, or that a user intentionally increases or decreases the application force of one trace in relation to another trace.

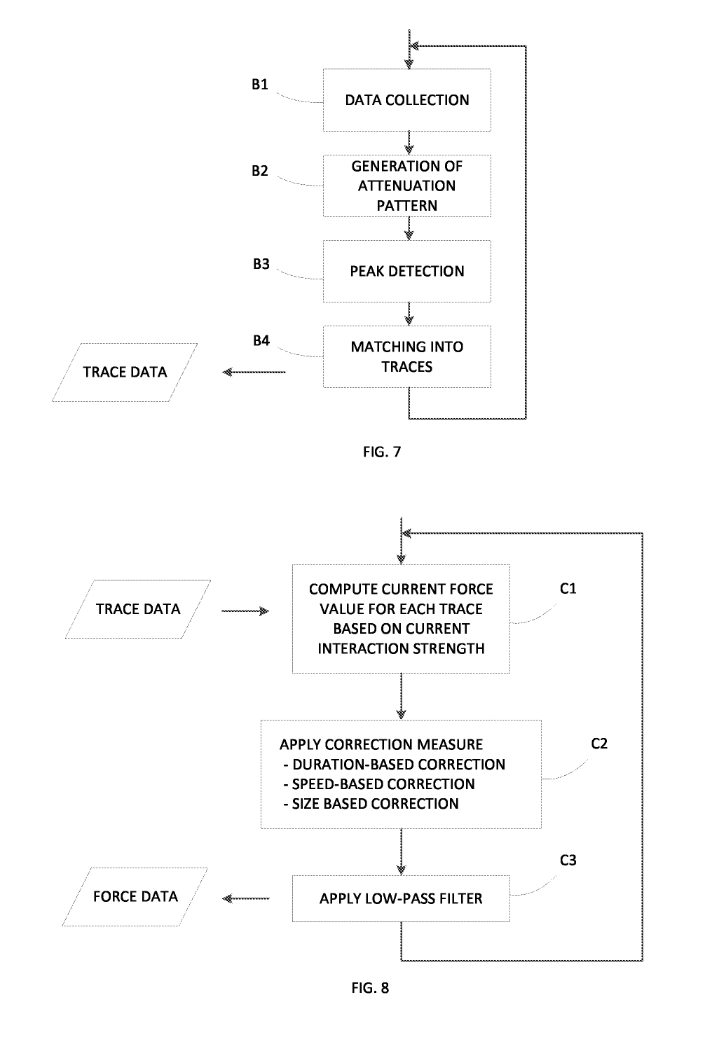

FIG. 8 is a flow chart of a force estimation process according to one embodiment. The force estimation process operates on the trace data provided by the data extraction process in FIG. 7. It should be noted that the process in FIG. 8 operates in synchronization with the process in FIG. 7, such that the trace data resulting from a frame in FIG. 7 is then processed in a frame in FIG. 8. In a first step C1, a current force value for each trace is computed based on the current attenuation of the respective trace given by the trace data. In one implementation, the current force value may be set equal to the attenuation, and step C1 may merely amount to obtaining the attenuation from the trace data. In another implementation, step C1 may involve a scaling of the attenuation. Following step C1, the process may proceed directly to step C3. However, to improve the accuracy of the estimated force values, step C2 applies one or more of a number of different corrections to the force values generated in step C1. Step C2 may thus serve to improve the reliability of the force values with respect to relative changes in application force, reduce noise (variability) in the resulting time series of force values that are generated by the repeated execution of steps C1-C3, and even to counteract unintentional changes in application force by the user. As indicated in FIG. 8, step C2 may include one or more of a duration correction, a speed correction, and a size correction. The low-pass filtering step C3 is included to reduce variations in the time series of force values that are produced by step C1/C2. Any available low-pass filter may be used.

Thus, each trace now also has force values, thus, the trace data includes positions (xₙₜ, yₙₜ) and forces (also referred to as pressure) (pₙₜ) for each trace. These data can be used as touch input data to the gesture interpretation unit 13 (FIG. 1).

The present invention is not limited to the above-described preferred embodiments. Various alternatives, modifications and equivalents may be used.

Therefore, the above embodiments should not be taken as limiting the scope of the invention, which is defined by the appending claims.

1. A method, comprising:
presenting a graphical interactive object via a graphical user interface, GUI, of a touch sensing device wherein the GUI is visible via a touch surface of the touch sensitive device;
receiving touch input data indicating touch inputs on the touch surface, and determining from said touch input data:
a first touch input from a first object of a user at a first position on the touch surface, and
a second touch input from a second object of a user at a second position on the touch surface, wherein said first and second positions are in a relation to the graphical interactive object corresponding to a grabbing input; and while continuous contact of said first and second objects with the touch surface is maintained:
determining from said touch input data if movement of at least one of said first and second touch inputs has occurred, and if movement has occurred, moving the graphical interactive object in accordance with the determined movement;
determining from said touch input data if an increased pressure compared to a threshold of at least one of the first and second touch inputs has occurred, and if an increased pressure has occurred, processing the graphical interactive object in response to the determined increased pressure.

2. The method according to claim 1, wherein the step of processing the graphical interactive object comprising processing the graphical interactive object according to a first action when an increased pressure of the first touch input is determined, and/or processing the graphical interactive object according to a second action when an increased pressure of the second touch input is determined.

3. The method according to claim 1, wherein the step of processing the graphical interactive object comprises processing the graphical interactive object according to a third action when essentially simultaneous increased pressures of the first and second touch inputs are determined.

4. The method according to claim 1, wherein said grabbing input is determined by determining from said touch input data that the first and second positions are arranged in space and/or in time according to a certain rule or rules.

5. The method according to claim 1, wherein the first and second positions are arranged such that they coincide at least in some extent with the graphical interactive object during overlapping time periods.

6. The method according to claim 4, comprising determining a line corresponding to a distance between the first and second positions wherein a grabbing input corresponds to first and second positions which during overlapping time periods are arranged such that the line coincide with said graphical interactive object.

7. The method according to claim 1, wherein said determination of movement of at least one of said first and second touch inputs comprising determining from said touch input data that at least one of said first and second touch inputs are arranged in space and/or in time in a manner corresponding to movement of the at least one of said first and second touch inputs.

8. The method according to claim 7, comprising determining a line corresponding to a distance between the first and second touch inputs and moving the interactive graphical object as a function of the line when movement of at least one of said first and second touch inputs is determined.

9. The method according to claim 1, wherein said touch input data comprising positioning data xₙₜ, yₙₜ and pressure data pₙₜ.

10. The method according to claim 1, wherein the touch sensing device is an FTIR-based (Frustrated Total Internal Reflection) touch sensing device.

11. A computer readable storage medium comprising computer programming instructions which, when executed on a processor, are configured to carry out the method of claim 1.

12. A gesture interpretation unit comprising a processor configured to receive a touch signal s, comprising touch input data indicating touch inputs on a touch surface of a touch sensing device, the unit further comprises a computer readable storage medium storing instructions operable to cause the processor to perform operations comprising:
presenting a graphical interactive object via a graphical user interface, GUI, wherein the GUI is visible via the touch surface;
determining from said touch input data:
a first touch input from a first object of a user at a first position on the touch surface, and
a second touch input from a second object of a user at a second position on the touch surface, wherein said first and second positions are in a relation to the graphical interactive object corresponding to a grabbing input, and while continuous contact of said first and second objects with the touch surface is maintained:
determining from said touch input data if movement of at least one of said first and second touch inputs has occurred, and if movement has occurred, moving the graphical interactive object in accordance with the determined movement;
determining from said touch input data if an increased pressure compared to a threshold of at least one of the first and second touch inputs has occurred, and if an increased pressure has occurred, processing the graphical interactive object in response to the determined increased pressure.

13. The unit according to claim 12, including instructions for processing the graphical interactive object according to a first action when an increased pressure of the first touch input is determined, and/or processing the graphical interactive object according to a second action when an increased pressure of the second touch input is determined.

14. The unit according to claim 12, including instructions for processing the graphical interactive object according to a third action when essentially simultaneous increased pressures of the first and second touch inputs are determined.

15. The unit according to claim 12, including instructions for determining a grabbing input comprising determining from the touch input data that the first and second positions are arranged in space and/or in time according to a certain rule or rules.

16. The unit according to claim 15, including instructions for determining that the first and second positions are arranged such that they coincide at least in some extent with the graphical interactive object during overlapping time periods.

17. The unit according to claim 15, including instructions for determining a line corresponding to a distance between the first and second positions wherein a grabbing input corresponds to first and second positions which during overlapping time periods are arranged such that the line coincides with said graphical interactive object.

18. The unit according to claim 12, including instructions for determining from said touch input data that at least one of said first and second touch inputs are arranged in space and/or in time in a manner corresponding to movement of said at least one of the first and second touch inputs.

19. The unit according to claim 18, including instructions for determining a line corresponding to a distance between the first and second touch inputs and continuously moving the interactive graphical object as a function of the line, when movement of at least one of said first and second touch inputs is determined.

20. The unit according to claim 12, wherein said touch input data comprises positioning data xnₜ, ynₜ and pressure data pnₜ.

21. A touch sensing device comprising
a touch arrangement comprising a touch surface, wherein the touch arrangement is configured to detect touch inputs on said touch surface and to generate a signal s_{y} indicating said touch inputs;
a touch control unit configured to receive said signal s_{y} and to determine touch input data from said touch input, and generate a touch signal s, indicating the touch input data;
a gesture interpretation unit according to claim 11, wherein the gesture interpretation unit is configured to receive said touch signal sₓ.

22. The device according to claim 21, wherein the device is an FTIR-based (Frustrated Total Internal Reflection) touch sensing device.
